(19) United States
(12) Patent Application Publication
(10) Pub. No.: US 2022/0381744 A1
(43) Pub. Date: Dec. 1, 2022

(54) METHOD FOR DETERMINING WHOLE MACRO-MICRO PROCESS OF ROCK DEFORMATION AND FAILURE BASED ON FOUR-PARAMETER TEST

(71) Applicant: CHINA UNIVERSITY OF MINING AND TECHNOLOGY, Xuzhou (CN)

(72) Inventors: Yanan GAO, Xuzhou (CN); Donghao LAN, Xuzhou (CN); Yudong ZHANG, Xuzhou (CN); Yunlong WANG, Xuzhou (CN); Peng GUO, Xuzhou (CN); Feng GAO, Xuzhou (CN)

(73) Assignee: CHINA UNIVERSITY OF MINING AND TECHNOLOGY, Xuzhou (CN)

(21) Appl. No.: 17/745,077

(22) Filed: May 16, 2022

(30) Foreign Application Priority Data
May 20, 2021 (CN) 202110549984.9

(51) Int. Cl. G01N 29/22

(52) U.S. Cl. CPC G01N 29/227; G01N 29/221; G01N 2203/0067

(57) ABSTRACT

Disclosed is a method for determining a whole macro-micro process of rock deformation and failure based on a four-parameter test, including following steps: firstly, obtaining acoustic emission data and deformation data of a sample in a compression test, and then calculating the deformation data according to a finite deformation theory to obtain a mean rotation angle θ at each stress level; using Grassberger-Procaccia (G-P) algorithm to calculate the acoustic emission data, and obtaining a fractal dimension of a temporal distribution D_{T} of an acoustic emission signal and calculating a fractal dimension of a spatial distribution D_{S}; obtaining a microscopic morphology of a fracture surface by scanning electron microscope (SEM) test after the compression test, and calculating a fractal dimension D_{A} of the fracture surface; finally, obtaining a mathematical trend relationship between θ and D_{T}, D_{S} and D_{A} according to a comprehensive analysis of D_{T}, D_{S}, D_{A} and θ.

### CROSS-REFERENCE TO RELATED APPLICATIONS

This application claims priority to Chinese Patent Application No. 202110549984.9, filed on May 20, 2021, the contents of which are hereby incorporated by reference.

### TECHNICAL FIELD

The application relates to a method for determining rock deformation and failure, and in particular to a method for determining a whole macro-micro process of rock deformation and failure based on a four-parameter test.

### BACKGROUND

At present, the deformation and failure of rocks is the main factor that induces the disasters in practical engineering such as mines, underground spaces, tunnels and dams. As a service life of rock engineering increases, accumulation of rock deformation and damage, which may result in the collapse of engineering structure corresponding to the rock mass, threatens people's lives and engineering safety.

This deformation process may associate with the macroscopic damage and microscopic structural changes of rock. Rock deformation and failure have attracted much attention in mines, underground spaces, tunnels, dams and other projects. Because of the complexity of rock deformation and failure, to reveal its mechanism, it is necessary to analyze it from both macro and micro perspectives, and build a bridge between macro failure process and micro structural change. However, at present, macro and micro parameters are measured and analyzed independently, but no connection has been established. Therefore, how to provide a method to establish a quantitative relationship between macro and micro in the whole process of rock deformation and failure is a research direction of this industry, which is important to provide theoretical support for follow-up researches.

### SUMMARY

Aiming at the problems existing in the prior art, the present disclosure provides method for determining a whole macro-micro process of rock deformation and failure based on a four-parameter test, which establishes the quantitative relationship between macro and micro of the whole process of rock deformation and failure, and provides theoretical support for subsequent research.

In order to achieve the above objectives, the technical scheme adopted by the disclosure is as follows: a method for determining a whole macro-micro process of rock deformation and failure based on a four-parameter test which specifically comprises following steps:

S1: sampling an engineering rock mass to be tested, and processing a sampled rock mass into a cylindrical specimen;

S2: placing the cylindrical specimen on a testing machine in a compression test system, sticking a deformation sensor and an acoustic emission probe on a surface of the cylindrical specimen, then starting a compression test, and collecting acoustic emission data through the acoustic emission probe and deformation data on the surface of the cylindrical specimen through the deformation sensor while the compression test is being carried out;

S3: calculating the deformation data collected in S2 according to a finite deformation theory, and obtaining a parameter-mean rotation angle θ, which characterizes a macroscopic deformation characteristic of materials at each stress level and is specifically:

Fⱼⁱ=Sⱼⁱ+Rⱼⁱ (1),

where Fⱼⁱ is a deformation gradient; orthogonal transformation Rⱼⁱ is a rotation tensor; symmetric transformation Sⱼⁱ is a strain tensor, and an expression of Sⱼⁱ is as follows:

$${S}_{j}^{i} = \frac{1}{2} ( {u}^{i} {\vert}_{j} + {u}^{j} {\vert}_{i} ) - ( 1 - cos θ ) {L}_{k}^{i} {L}_{j}^{k} , \qquad ( 2 )$$

during a test measurement, calculating out a strain component based on a small deformation theory, namely:

$${ε}_{j}^{i} = \frac{1}{2} ( {u}^{i} {\vert}_{j} + {u}^{j} {\vert}_{i} ) , \qquad ( 3 )$$

where uⁱ|ⱼ is a covariant derivative of displacement and εⱼⁱ is a small deformation strain;

combined a small deformation strain component with a finite deformation strain component to get:

Sⱼⁱ=εⱼⁱ−(1−cos θ)LₖⁱLⱼⁱ (4),

where Lⱼ^{k} is azimuth tensor of a rotation axis;

according to Hooke's law, one-dimensional elastic lossless constitutive formula is

σ=ES (5),

from formula (4) and formula (5), getting

σ=Eεⱼⁱ−E(1−cos θ)LₖⁱLⱼ^{k} (6),

where σ is a stress;

extending formula (6) to a three-dimensional state and writing the formula (6) as

$$\{ \begin{matrix}{σ}_{1}^{1} = E {ε}_{1}^{1} - E ( 1 - cos θ ) {L}_{k}^{i} {L}_{j}^{k} + μ ( {σ}_{2}^{2} + {σ}_{3}^{3} ) \\ {σ}_{2}^{2} = E {ε}_{2}^{2} - E ( 1 - cos θ ) {L}_{k}^{i} {L}_{j}^{k} + μ ( {σ}_{1}^{1} + {σ}_{3}^{3} ) \\ {σ}_{3}^{3} = E {ε}_{3}^{3} - E ( 1 - cos θ ) {L}_{k}^{i} {L}_{j}^{k} + μ ( {σ}_{2}^{2} + {σ}_{1}^{1} )\end{matrix} , \qquad ( 7 )$$

in a triaxial test, σ₂²=σ₃³=σ_{con}, combined with formula (10), getting:

$$\frac{{σ}_{1}^{1} - 2 {μσ}_{con}}{E} = {ε}_{1}^{1} - ( 1 - cos θ ) {L}_{k}^{1} {L}_{1}^{k} , \qquad ( 8 )$$

in a triaxial compression test, there being an assumption as follows:

(L₂¹)²=(L₃²)²=(L₁³)² (9),

writing formula (8) as

$$\frac{{σ}_{1}^{1} - 2 μ {σ}_{con}}{E} = {ε}_{1}^{1} + \frac{2}{3} ( 1 - cos θ ) , \qquad ( 10 )$$

obtaining a formula for calculating the mean rotation angle θ from formula (12):

$$θ = arccos ( 1 - \frac{3}{2} ( \frac{{σ}_{1}^{1} - 2 μ {σ}_{con}}{E} - {ε}_{1}^{1} ) ) , \qquad ( 11 )$$

so as to calculate the mean rotation angle θ;

S4: using Grassberger-Procaccia (G-P) algorithm on the acoustic emission data collected in S2 to calculate a fractal dimension of a temporal distribution D_{T} of an acoustic emission signal and calculating a fractal dimension of a spatial distribution D_{S} according to a spatial projection method; specifically:

taking time series of the acoustic emission signal as a research object, then corresponding each time series to a series set with a capacity of n:

X={x₁,x₂, . . . ,xₙ} (12),

constructing formula (12) as a m-dimensional phase space (m<n), firstly, taking m numbers as a vector of m-dimensional space

X₁={x₁,x₂,x₃, . . . ,xₘ} (13),

then shifting one data to the right and taking m numbers again to form another vector, and so on to form N=n−m+1 vectors; the corresponding correlation function is:

$$W ( r ) = \frac{1}{{N}^{2}} {\sum }_{i = 1}^{N} {\sum }_{j = 1}^{N} H [ r - \vert {X}_{i} - {X}_{j} \vert ] , \qquad ( 14 )$$

where H is Heaviside function; r is a given scale; when assigning a value to scale r, making r=kr₀ in order to avoid dispersion, where k is taken as a scale coefficient and

$${r}_{0} = \frac{1}{{N}^{2}} {\sum }_{i = 1}^{N} {\sum }_{j = 1}^{N} \vert {X}_{i} - {X}_{j} \vert ;$$

obtaining n points in a double logarithmic coordinate system, and performing data fitting on T1 points. If the result is a straight line, it shows that the acoustic emission series has fractal characteristics in a given scale range, and a slope of the straight line is the fractal dimension of the temporal distribution D_{T} of the acoustic emission parameter, namely

D_{T}=1 gW(r)/1 g(r) (15).

For D_{S}, the space box dimension is used. The box dimension is defined as:

N(r)=Cr^{-D}^{_{S}} (16),

where N(r) is the number of discrete bodies whose characteristic size is greater than r, C is a material constant, and the other form of the above formula is the number-radius relation as follows:

M(r)=Cr^{-D}^{_{S}} (17),

where r is different radii covering natural discrete bodies, and M(r) is the number of discrete bodies covered in a circle with radius of r. Taking the logarithm on both sides to get:

1 gM(r)=1 gC+D_{S}1 g(r) (18),

where D_{S} is the fractal dimension of the spatial distribution;

S5: carrying out a scanning electron microscope (SEM) test on a fracture surface of the sample after the compression test is completed, to obtain a microscopic morphology of the fracture surface, observing the morphology of the fracture surface and calculating the fractal dimension D_{A} of the fracture surface.

The number of units needed to cover an image in units of δ is N(δ), D_{A}=−log (N(δ))/log δ.

S6: because of a correspondence of a change of the mean rotation angle θ to each process of rock deformation, including a compaction stage, a linear stage and a plastic yield stage in a compression process, finally obtaining a mathematical trend relationship between θ and D_{T}, D_{S} and D_{A} through comprehensively analyzing the obtained fractal dimension of the temporal distribution D_{T} of the acoustic emission, the fractal dimension of the spatial distribution D_{S} of the acoustic emission and the fractal dimension D_{A} of the fracture surface at each stress level (prior to a peak strength) and the mean rotation angle θ at a same stress level, as shown in a following formula,

θ=a*D_{T}+b*D_{S}+c*D_{A} (19),

eventually, obtaining values of a, b and c, so as to establish the quantitative relationship between macro and micro in the whole process of rock deformation and failure.

Further, a height of the cylindrical specimen is 100 mm and a diameter of the cylindrical specimen is 50 mm.

Further, the deformation data includes axial deformation and circumferential deformation.

Compared with the prior art, the disclosure firstly obtains acoustic emission data and deformation data of the sample through the deformation sensor and the acoustic emission probe in the process of the sample compression test, and then calculates the deformation data according to the finite deformation theory to obtain a parameter-mean rotation angle θ which represents the macroscopic deformation characteristics of the material at each stress level; G-P algorithm is used to calculate the acoustic emission data, and the fractal dimension of the temporal distribution D_{T} of acoustic emission signal is obtained, and the fractal dimension of the spatial distribution D_{S} is calculated according to the spatial projection method. After the compression test, the microscopic morphology of the fracture surface is obtained by a scanning electron microscope (SEM) test, and the fractal dimension D_{A} of the fracture surface is calculated out. Finally, the mathematical trend relationship between θ and D_{T}, D_{S} and D_{A} is obtained through comprehensively analysing the obtained fractal dimension of the temporal distribution D_{T} of the acoustic emission, the fractal dimension of the spatial distribution D_{S} of the acoustic emission and fractal dimension D_{A} of the fracture surface at each stress level (prior to a peak strength) and the mean rotation angle θ at a same stress level, thus establishing a quantitative relationship between macro and micro in the whole process of rock deformation and failure and providing theoretical support for follow-up researches.

### BRIEF DESCRIPTION OF THE DRAWINGS

FIG. 1 is a flow chart of a method for determining a whole macro-micro process of rock deformation and failure based on a four-parameter test according to an embodiment of the present disclosure.

### DETAILED DESCRIPTION OF THE EMBODIMENTS

The technical solutions in the embodiments of the present disclosure will be clearly and completely described below. Obviously, the described embodiments are only part of the embodiments in this disclosure, but not all of them. Based on the embodiment in this disclosure, all other embodiments obtained by ordinary technicians in this field without creative effort are within the scope of protection in this disclosure.

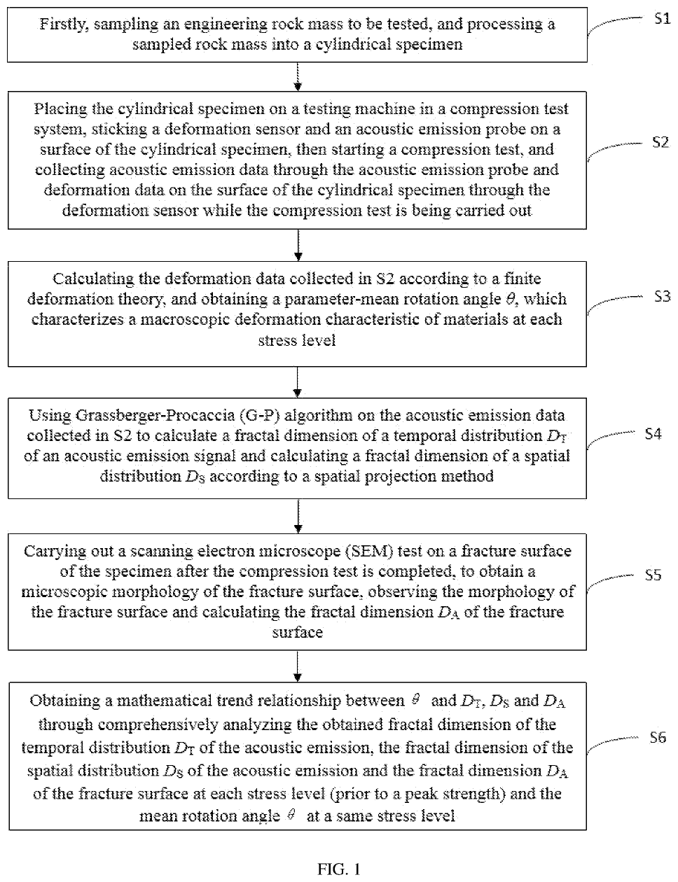

As shown in FIG. 1, specific steps of this embodiment are as follows:

S1: firstly, sampling an engineering rock mass to be tested, and processing a sampled rock mass into a cylindrical specimen whose height is 100 mm high and diameter is 50 mm.

S2: placing the cylindrical specimen on a testing machine in a compression test system, sticking a deformation sensor and an acoustic emission probe on a surface of the cylindrical specimen, then starting a compression test, and collecting acoustic emission data through the acoustic emission probe and deformation data on the surface of the cylindrical specimen through the deformation sensor while the compression test is being carried out; with the deformation data comprising axial deformation and circumferential deformation.

S3: calculating the deformation data collected in S2 according to a finite deformation theory, and obtaining a parameter—mean rotation angle θ, which characterizes a macroscopic deformation characteristic of materials at each stress level and is specifically:

Fⱼⁱ=Sⱼⁱ+Rⱼⁱ (1),

where Fⱼⁱ is a deformation gradient, orthogonal transformation Rⱼⁱ is a rotation tensor while symmetric transformation Sⱼⁱ is a strain tensor, and an expression of Sⱼⁱ is as follows:

$${S}_{j}^{i} = \frac{1}{2} ( {u}^{i} {\vert}_{j} + {u}^{j} {\vert}_{i} ) - ( 1 - cos θ ) {L}_{k}^{i} {L}_{j}^{k} , \qquad ( 2 )$$

during a test measurement, calculating out a strain component based on a small deformation theory below:

$${ε}_{j}^{i} = \frac{1}{2} ( {u}^{i} {\vert {}_{j} + {u}^{j} \vert}_{i} ) , \qquad ( 3 )$$

where uⁱ|ⱼ is a covariant derivative of displacement and εⱼⁱ is a small deformation strain;

combined a small deformation strain component with a finite deformation strain component, getting:

Sⱼⁱ=εⱼⁱ−(1−cos θ)LₖⁱLⱼⁱ (4),

where Lⱼ^{k}, is an azimuth tensor of a rotation axis;

according to Hooke's law, one-dimensional elastic lossless constitutive formula is

σ=ES (5),

from formula (4) and formula (5), getting

σ=Eεⱼⁱ−E(1−cos θ)LₖⁱLⱼ^{k} (6),

where σ is a stress;

extending formula (6) to a three-dimensional state and writing formula (6) as

$$\{ \begin{matrix}{σ}_{1}^{1} = E {ε}_{1}^{1} - E ( 1 - cos θ ) {L}_{k}^{i} {L}_{j}^{k} + μ ( {σ}_{2}^{2} + {σ}_{3}^{3} ) \\ {σ}_{2}^{2} = E {ε}_{2}^{2} - E ( 1 - cos θ ) {L}_{k}^{i} {L}_{j}^{k} + μ ( {σ}_{1}^{1} + {σ}_{3}^{3} ) \\ {σ}_{3}^{3} = E {ε}_{3}^{3} - E ( 1 - cos θ ) {L}_{k}^{i} {L}_{j}^{k} + μ ( {σ}_{2}^{2} + {σ}_{1}^{1} )\end{matrix} , \qquad ( 7 )$$

in a triaxial test, σ₂²=σ₃³=σ_{con}, combined with formula (10), getting:

$$\frac{{σ}_{1}^{1} - 2 {μσ}_{con}}{E} = {ε}_{1}^{1} - ( 1 - cos θ ) {L}_{k}^{1} {L}_{1}^{k} , \qquad ( 8 )$$

in a triaxial compression test, there being an assumption as follows:

(L₂¹)²=(L₃²)²=(L₁³)² (9),

writing formula (8) as

$$\frac{{σ}_{1}^{1} - 2 {μσ}_{con}}{E} = {ε}_{1}^{1} + \frac{2}{3} ( 1 - cos θ ) , \qquad ( 10 )$$

obtaining a formula for calculating the mean rotation angle θ from formula (12):

$$θ = arccos ( 1 - \frac{3}{2} ( \frac{{σ}_{1}^{1} - 2 {μσ}_{con}}{E} - {ε}_{1}^{1} ) ) , \qquad ( 11 )$$

so as to calculate the mean rotation angle θ;

S4: using Grassberger-Procaccia (G-P) algorithm on the acoustic emission data collected in S2 to calculate a fractal dimension of a temporal distribution D_{T} of an acoustic emission signal and calculating a fractal dimension of a spatial distribution D_{S} according to a spatial projection method; specifically:

taking time series of the acoustic emission signal as a research object, then corresponding each time series to a series set with a capacity of n:

X={x₁,x₂, . . . ,xₙ} (12),

constructing formula (12) as a m-dimensional phase space (m<n), firstly, taking m numbers as a vector of m-dimensional space

X₁={x₁,x₂,x₃, . . . ,xₘ} (13),

then shifting one data to the right and taking m numbers again to form another vector, and so on to form N=n−m+1 vectors; the corresponding correlation function is:

$$W ( r ) = \frac{1}{{N}^{2}} {\sum }_{i = 1}^{N} {\sum }_{j = 1}^{N} H [ r - \vert {X}_{i} - {X}_{j} \vert ] , \qquad ( 14 )$$

where H is Heaviside function; r is a given scale; when assigning a value to scale r, making r=kr₀ in order to avoid dispersion, where k is taken as a scale coefficient and

$${r}_{0} = \frac{1}{{N}^{2}} {\sum }_{i = 1}^{N} {\sum }_{j = 1}^{N} \vert {X}_{i} - {X}_{j} \vert ;$$

obtaining n points in a double logarithmic coordinate system, and performing data fitting on n points. If the result is a straight line, it shows that the acoustic emission series has fractal characteristics in a given scale range, and a slope of the straight line is the fractal dimension of the temporal distribution D_{T} of the acoustic emission parameter, namely

D_{T}=1 gW(r)/1 g(r) (15).

For D_{S}, the space box dimension is used. The box dimension is defined as:

N(r)=Cr^{-D}^{_{S}} (16),

where N(r) is the number of discrete bodies whose characteristic size is greater than r, C is a material constant, and the other form of the above formula is the number-radius relation as follows:

M(r)=Cr^{-D}^{_{S}} (17),

where r is different radii covering natural discrete bodies, and M(r) is the number of discrete bodies covered in a circle with radius of r. Taking the logarithm on both sides to get:

1 gM(r)=1 gC+D_{S}1 g(r) (18),

where D_{S} is the fractal dimension of the spatial distribution;

S5: carrying out a scanning electron microscope (SEM) test on a fracture surface of the sample after the compression test is completed, to obtain a microscopic morphology of the fracture surface, observing the morphology of the fracture surface and calculating the fractal dimension D_{A} of the fracture surface.

The number of units needed to cover an image in units of δ is N(δ), D_{A}=−log(N(δ))/log δ.

S6: because of a correspondence of a change of the mean rotation angle θ to each process of rock deformation, including a compaction stage, a linear stage and a plastic yield stage in a compression process, finally obtaining a mathematical trend relationship between θ and D_{T}, D_{S} and D_{A} through comprehensively analyzing the obtained the fractal dimension of the temporal distribution D_{T} of the acoustic emission, the fractal dimension of the spatial distribution D_{S} of the acoustic emission and the fractal dimension D_{A} of the fracture surface at each stress level (prior to a peak strength) and the mean rotation angle θ at a same stress level, as shown in a following formula,

θ=a*D_{T}+b*D_{S}+c*D_{A} (19),

eventually obtaining values of a, b and c, so as to establish the quantitative relationship between macro and micro in the whole process of rock deformation and failure.

In this application, specific examples are used to explain the principle and implementation of this application. The explanations of the above examples are only used to help understand the methods and core ideas of this application. At the same time, according to the ideas in this application, there will be some changes in the specific implementation and application scope for ordinary technicians in this field. To sum up, the contents of this specification should not be construed as a limitation to this application.

What is claimed is:

1. A method for determining a whole macro-micro process of rock deformation and failure based on a four-parameter test, wherein specific steps comprise:
A: firstly sampling an engineering rock mass to be tested, and processing a sampled rock mass into a cylindrical specimen;
B: placing the cylindrical specimen on a testing machine in a compression test system, sticking a deformation sensor and an acoustic emission probe on a surface of the cylindrical specimen, then starting a compression test, and collecting acoustic emission data through the acoustic emission probe and deformation data on the surface of the cylindrical specimen through the deformation sensor while the compression test is being carried out;
C: calculating the deformation data collected in step B according to a finite deformation theory, and obtaining a parameter-mean rotation angle θ, wherein the parameter-mean rotation angle θ characterizes a macroscopic deformation characteristic of materials at each stress level below:
Fⱼⁱ=Sⱼⁱ+Rⱼⁱ (1),
wherein Fⱼⁱ is a deformation gradient, orthogonal transformation Rⱼⁱ is a rotation tensor and symmetric transformation Sⱼⁱ is a strain tensor, and an expression of Sⱼⁱ is as follows:
$${S}_{j}^{i} = \frac{1}{2} ( {u}^{i} {\vert {}_{j} + {u}^{j} \vert}_{i} ) - ( 1 - cos θ ) {L}_{k}^{i} {L}_{j}^{k} , \qquad ( 2 )$$
during a test measurement, calculating out a strain component based on a small deformation theory:
$${ε}_{j}^{i} = \frac{1}{2} ( {u}^{i} {\vert {}_{j} + {u}^{j} \vert}_{i} ) , \qquad ( 3 )$$
wherein uⁱ|ⱼ is a covariant derivative of displacement and εⱼⁱ is a small deformation strain; combined a small deformation strain component with a finite deformation strain component to get:
Sⱼⁱ=εⱼⁱ−(1−cos θ)LₖⁱLⱼ^{k} (4),
wherein Lⱼ^{k} is azimuth tensor of a rotation axis;
wherein according to Hooke's law, a one-dimensional elastic lossless constitutive formula is
σ=ES (5),
from formula (4) and formula (5), getting
σ=Eεⱼⁱ−E(1−cos θ)LₖⁱLⱼ^{k} (6),
wherein a is a stress;
extending formula (6) to a three-dimensional state and writing formula (6) as
$$\{ \begin{matrix}{σ}_{1}^{1} = E {ε}_{1}^{1} - E ( 1 - cos θ ) {L}_{k}^{i} {L}_{j}^{k} + μ ( {σ}_{2}^{2} + {σ}_{3}^{3} ) \\ {σ}_{2}^{2} = E {ε}_{2}^{2} - E ( 1 - cos θ ) {L}_{k}^{i} {L}_{j}^{k} + μ ( {σ}_{1}^{1} + {σ}_{3}^{3} ) \\ {σ}_{3}^{3} = E {ε}_{3}^{3} - E ( 1 - cos θ ) {L}_{k}^{i} {L}_{j}^{k} + μ ( {σ}_{2}^{2} + {σ}_{1}^{1} )\end{matrix} , \qquad ( 7 )$$
in a triaxial test, σ₂²=σ₃³=σ_{con}, combined with formula (10), getting:
$$\frac{{σ}_{1}^{1} - 2 {μσ}_{con}}{E} = {ε}_{1}^{1} - ( 1 - cos θ ) {L}_{k}^{1} {L}_{1}^{k} , \qquad ( 8 )$$
in a triaxial compression test, there being an assumption as follows:
(L₂¹)²=(L₃²)²=(L₁³)² (9),
writing formula (8) as
$$\frac{{σ}_{1}^{1} - 2 {μσ}_{con}}{E} = {ε}_{1}^{1} + \frac{2}{3} ( 1 - cos θ ) , \qquad ( 10 )$$
obtaining a formula for calculating the mean rotation angle θ from formula (12):
$$θ = arccos ( 1 - \frac{3}{2} ( \frac{{σ}_{1}^{1} - 2 {μσ}_{con}}{E} - {ε}_{1}^{1} ) ) , \qquad ( 11 )$$
so as to calculate the mean rotation angle θ;
D: using Grassberger-Procaccia (G-P) algorithm on the acoustic emission data collected in step B to calculate a fractal dimension of a temporal distribution D_{T} of an acoustic emission signal and calculating a fractal dimension a spatial distribution D_{S} according to a spatial projection method; specifically:
taking time series of the acoustic emission signal as a research object, and then corresponding each time series to a series set with a capacity of n:
X={x₁,x₂, . . . ,xₙ} (12),
constructing the formula (12) as a m-dimensional phase space (m<n), firstly, taking m numbers as a vector of m-dimensional space
X={x₁,x₂,x₃, . . . ,xₘ} (13),
then shifting one data to the right and taking m numbers again to form another vector, and so on to form N=n−m+1 vectors, wherein a corresponding correlation function is:
$$W ( r ) = \frac{1}{{N}^{2}} {\sum }_{i = 1}^{N} {\sum }_{j = 1}^{N} H [ r - \vert {X}_{i} - {X}_{j} \vert ] , \qquad ( 14 )$$
wherein H is a Heaviside function, r is a given scale; when assigning a value to scale r, making r=kr₀ in order to avoid dispersion, where k is taken as a scale coefficient and
$${r}_{0} = \frac{1}{{N}^{2}} {\sum }_{i = 1}^{N} {\sum }_{j = 1}^{N} \vert {X}_{i} - {X}_{j} \vert ;$$
obtaining n points in a double logarithmic coordinate system, and performing data fitting on n points; wherein if a result is a straight line, the result means that the acoustic emission series has fractal characteristics in a given scale range, and a slope of the straight line is the fractal dimension of the temporal distribution D_{T} of the acoustic emission parameter,
D_{T}=1 gW(r)/1 g(r) (15),
for D_{S}, using a space box dimension to cover it, with the box dimension defined as:
N(r)=Cr^{-D}^{_{S}} (16),
wherein N(r) is the number of discrete bodies whose characteristic size is greater than, C is a material constant, and the other form of the above formula is the number-radius relation as follows:
M(r)=Cr^{-D}^{_{S}} (17),
wherein r is different radii covering natural discrete bodies, and M(r) is the number of discrete bodies covered in a circle with a radius of r; taking the logarithm on both sides to get:
1 gM(r)=1 gC+D_{S}1 g(r) (18),
wherein D_{S} is the fractal dimension of the spatial distribution;
E: carrying out a scanning electron microscope (SEM) test on a fracture surface of the specimen after the compression test is completed, to obtain a microscopic morphology of the fracture surface, observing the morphology of the fracture surface and calculating the fractal dimension D_{A} of the fracture surface;
wherein the number of units needed to cover an image in units of δ is N(δ), D_{A}=−log(N(δ))/log δ;
F: because of a correspondence of a change of the mean rotation angle θ to each process of rock deformation, including a compaction stage, a linear stage and a plastic yield stage in a compression process, finally obtaining a mathematical trend relationship between θ and D_{T}, D_{S} and D_{A} through comprehensively analyzing the obtained fractal dimension of the temporal distribution D_{T} of the acoustic emission, the fractal dimension of the spatial distribution D_{S} of the acoustic emission and the fractal dimension D_{A} of the fracture surface at each stress level prior to a peak strength and the mean rotation angle θ at a same stress level, as shown in a following formula,
θ=a*D_{T}+b*D_{S}+c*D_{A} (19),
lastly obtaining values of a, b and c, so as to establish a quantitative relationship between macro and micro in a whole process of rock deformation and failure.

2. The method for determining a whole macro-micro process of rock deformation and failure based on a four-parameter test according to claim 1, wherein a height of the cylindrical specimen is 100 mm and a diameter of the cylindrical specimen is 50 mm.

3. The method for determining a whole macro-micro process of rock deformation and failure based on a four-parameter test according to claim 1, wherein the deformation data comprises axial deformation and circumferential deformation.
